(19) United States
(12) Patent Application Publication
(10) Pub. No.: US 2015/0075060 A1
(43) Pub. Date: Mar. 19, 2015

(54) APPARATUS AND METHOD FOR DETECTION OF INSECTS

(71) Applicant: Jody Arthur Balsam, Burbank, CA (US)

(72) Inventor: Jody Arthur Balsam, Burbank, CA (US)

(21) Appl. No.: 14/027,705

(22) Filed: Sep. 16, 2013

(51) Int. Cl. A01M 1/02

(52) U.S. Cl. CPC A01M 1/02
USPC 43/123

(57) ABSTRACT

An apparatus and method for the detection of insects. The apparatus includes a chamber that includes an attractant to lure the bed bug to the chamber, a detector to detect the presences of an insect in the chamber, an indicator to alert the user that an insect has been detected, and a control circuit to process the signal from the detector to the indicator.

### CROSS-REFERENCE TO RELATED APPLICATIONS

This is a Continuation Application to pending Non-Provisional U.S. application Ser. No. 13/764,793, filed on Feb. 12, 2013, which is incorporated herein by this reference in its entirety and claims priority thereto.

### FIELD OF THE INVENTION

The invention is relevant in the field of bedbug inspections. The present invention will be saving valuable time and costly constant re-inspections. The field of bed bug preventive monitoring and concurrent bed bug inspections that are performed either by trained animals or human exterminators. The present device is specifically designed to be an ongoing early detection, of bed bugs by pest management professionals (“PMP”).

### BACKGROUND OF THE INVENTION

Bed bugs (Cimex lectularius and Cimex hemipterus) are small tick like looking insects that survive on the blood of humans and other warm-blooded hosts. Bed bugs most likely hide during daylight hours in dark enclosed sites and have a preference for cracks and crevices in fabric, wood, and gritty sandpaper like surfaces.

Bed bugs are attracted to heat, scented bedbug excrement and carbon dioxide given off by warm-blooded mammals, birds, and themselves. Sleeping areas, mattresses, box springs, nightstands, headboards, are an ideal environment for bedbugs to hide. Bed bugs are known for being mainly active at night, and prefer hunting in the dark making their sightings difficult.

The benefits of this invention would be best utilized by of the invention is for use by PMPs. The present invention would greatly diminish the inspection time for PMPs who spend countless hours inspecting and returning to bed bug traps on several occasions.

The bites inflicted by bed bugs can create a dermatological reaction, which can cause irritation for a considerable time after the bite occurs. The first indication of a bite usually occurs with the person not knowing exactly where or when the insect bit them. This creates the situation whereby a person may not now where they were bit. It may have been at a hotel, over a friend's house, the couch or their bed. In many instances, there is no reaction for many months or until sightings of the bed bugs are seen or the excrement and blood stains are found on the surface of where they are feeding frequently.

Waiting for the bed bugs to bite to confirm an intrusion, has many disadvantages, for example the bites are similar to other insect bites and therefore difficult to identify. Detecting the presence of bed bugs before they bite would be better result. The purpose of the invention is to lessen the amount of time it takes to detect bed bugs. For example, the click of a computer mouse can observe multipliable locations all at once for the PMP of the presence of bed bugs and that the units are all working properly.

The pandemic worldwide increase in bedbugs, highlights the need for a solution to the problems they cause and this brief review of known attempts to detect and eliminate them (all of which are based around active capture) shows that there is no clear starting point—and indeed no satisfactory universal solution from which the problem may be tackled, unless increased early detection is possible with the present bed bug insect peripheral electronic detection notification unit device. This device can be connected and part of many different apparatus device's with software system producing email or other electronic alerts to common personal electronic devices in the dark structure. Saving valuable time and costly constant re-inspection before a prolific infestation is problematic. This is the main benefit of the invention.

### SUMMARY OF THE INVENTION

The present invention addresses the above stated need by the invention seeks to lure and capture insects. The term insects may include bed bugs. The present invention is based on their known attraction to a non-sun light and non-room light structures along with many dark refuge enclosures. That includes grasping and gripping surfaces. Providing, hidden dark bonus cracks and crevices that are also offering, attractive things to their sensory organs. Commonly known, natural chemical attractants, such as bed bug excrement, also known as bed bug fecal pheromones, lure in bed bugs. Additional bed bug attractants or lures include warm heat and carbon dioxide. Bed bugs, when captured by the present invention produce information to set off an alarm, warning PMPs such as exterminators, hotel managers, apartment owners and other similarly situated individuals.

Once notified of the bedbug intruder alert: the knowledge gained from observation, the PMP has proof of intruder of bedbug immediately. The invention could notify from its location to the PMP by electronic mail, text message, IP, visual monitors, but not limited to other electronic peripheral common devices and or internet connections.

According to the first embodiment of bed bugs detected by the present invention there is absolute proof of bed bug detection.

The invention could elicit a taxis response to a PMP to schedule a treatment, for eradication of bed bugs. And immediately could be notifying another PMP designed to do so.

Before the eradication procedure begins, from the PMP, that perform the extermination of bed bugs, the invention placements are easily disconnected and removed for their protection, until after the structure has finished being treated for bed bugs.

After eradication procedures have taken place for the bed bugs in a room, then the original invention placements are re-set to their connective intelligence according to the instruction manual. This creates quality assurance of continual monitoring electronically, that any new re-invasions that may occur in the future. The invention will notify PMPs immediately.

The invention comprises a refuge enclosure, has a non-trapping/trapping indicator in the interior. It is the detection surface. Its enhanced purpose is to provide a constant visual electronic scope inspection for the security motion detection cameras and devices in conjunction for the early bed bug detection protection programs. An indicator may include an electronic message alert with may be an email or text message, visual identification on a TV screen, audible alarm or a first response alert notifying a pest management professional.

According to the another aspect of the present invention, it is there to provide an early warning passive method of detecting the presence of bed bugs with or without their capture held comprising of visual LCD/TV screen monitoring with digital video recorder with alert programming to the bedbugs movement within the invention. This device elicits a taxis response, from motion detection to DVR or computers with the common software for this operating systems management. That in turn, could notify the PMPs by electronic mail, text message, sounds, lights or other alerting mechanisms with the prospective and proper software.

When invention is placed in or is attached to under a bed frame, a bed headboard or a mattress edge, the bed bugs, but not limited to, will be enticed to crawl into the invention because of scented excrement lure, warm heat, crevices and location placement of the unit. When crawling within the dark infrared interior of the non-trapping/trapping indicator surface this will trigger the active device and may include to leave an indication of their presence. Identified such as on a, but not limited to Visual T.V., LCD screen, recorded VCR, DVR or Computer generated operating software in communication with the invention.

The self-inspecting device is self-supporting. But if at regular intervals, the Pest Management Professional will want to inspect the Screening Visual monitors for the presence of bed bugs at any time, or to confirm the invention is operating properly.

The invention that is connected to known bed bug hiding areas, may be held in place but not limited to, by a connecting clip, screws, glue, magnets or by the use of Velcro. This means the device can be easily removed for maintenance every six months or if eradication procedure's is to take place.

The Field invention peripheral device will be saving valuable time and costly constant re-inspections.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is the front perspective view of the invention.

FIG. 2 is the top perspective view of the invention.

FIG. 3 is the bottom perspective view of the invention.

FIG. 4 is the right side perspective view of the invention.

FIG. 5 is the perspective front view of the invention demonstrating only top of invention exploded, wherein the chamber is shown in transparency to show the inner details.

FIG. 6 is the entire exploded front side view of the invention, wherein the chamber is shown in transparency to show the inner details.

FIG. 7 is a schematic view of a room showing where the invention might be placed.

FIG. 8 is a flow chart of other common reactive electronic and non-electronic operating system devices.

### DETAILED DESCRIPTION

An embodiment of the invention will now be described, by way of example only, with compass references to the accompanying figure.

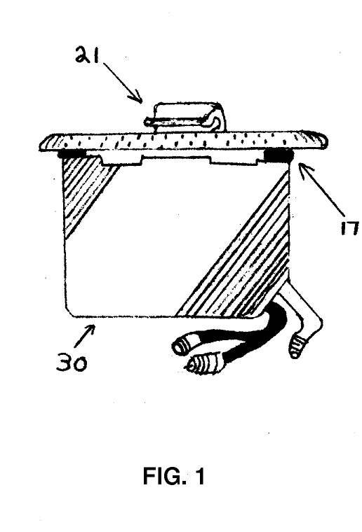

FIG. 1 is the front perspective view of the invention. A plastic rectangular looking box, referred to herein as a chamber, indicating the outer smooth encasement by slanted upgrading from left to right multiple lines indicating a smooth surface 1, 30. A beveled gritty sandpaper type plastic cover cap on top 3, 16 just slightly overlapping the edge of the embodiment 1. There is a crack where the bed bugs can enter, where the two meet. 2 On the top of cap of box is an attachment clip with a front view. 21 Along the bottom right side corner of embodiment, with one cable 31 protruding that splits in two, a power line connection 32 and a video feed line connection 18 and next protruding object 6 is a carbon dioxide inlet plastic tube connector. Any means to attract insects are referred to herein as an attractant. As a non-limiting example an attractant may be a gritty surface, crack or crevice, bed bug excrement scent lure, carbon dioxide inlet lure, warm heat from an infrared light unit.

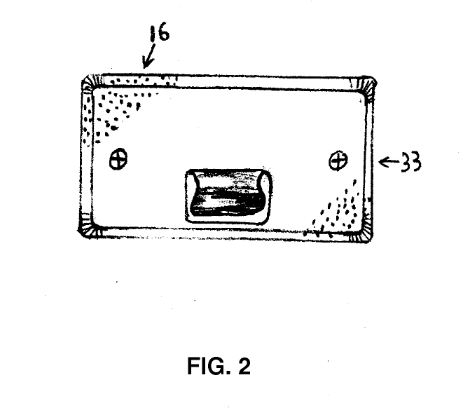

FIG. 2 is the Top Perspective view of the invention. A plastic cap that is treated with a gritty sandpaper type surface paint spray that is dried on the interior and exterior of the cap. 16 Showing dots in corners from upper left to lower right indicating gritty surface cap of FIG. 2 box attachment. This Top cap is connected with two screws 33 that is attached to the plastic encasement box smooth outer encasement 1, 30. Including on top of cap of box is a snap on attachment clip 21 with a top view.

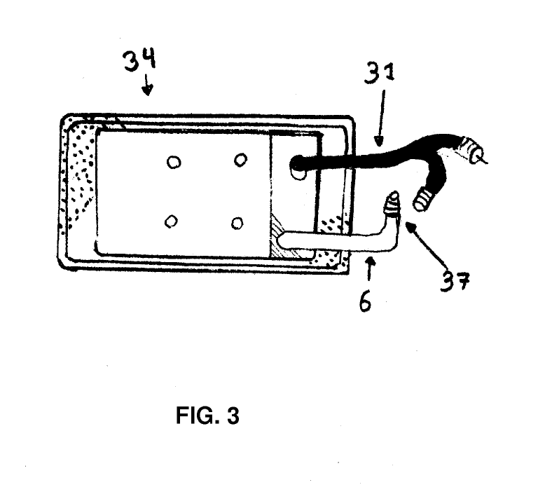

FIG. 3 is the Bottom Perspective view of the invention. There are four holes 34 that are used to place the bolts 35 thru to hold the camera 4 and led's 7 in place. The upside bottom surface 1 view showing indicating smooth surface (except for underneath 16 extended gritty cap). 2 On the right side of drawing with one cable 31 protruding that splits in two, a power line connection 32 and a video feed line 18 connection. The next protruding object is a carbon dioxide inlet 6 plastic tube connector.

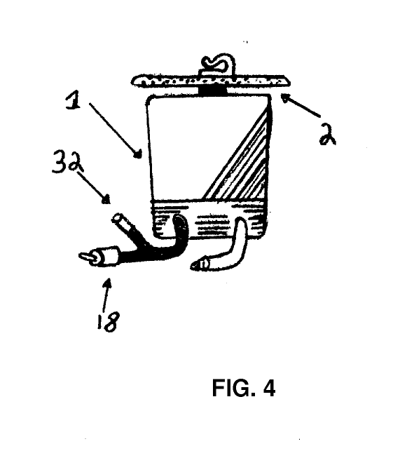

FIG. 4 is the Right Side Perspective view of the invention. Showing slanted upgrading from left to right multiple lines indicating smooth surface 30 except for gritty cap 16 at top of box. This is where the bedbugs can 2 enter. On the top of cap of box is an attachment clip with a right side view 21 Along the bottom corner of embodiment, with one cable 31 protruding that splits in two, a power line connection 32 and a video feed line connection 18 and next protruding object 6 is a carbon dioxide inlet plastic tube connector.

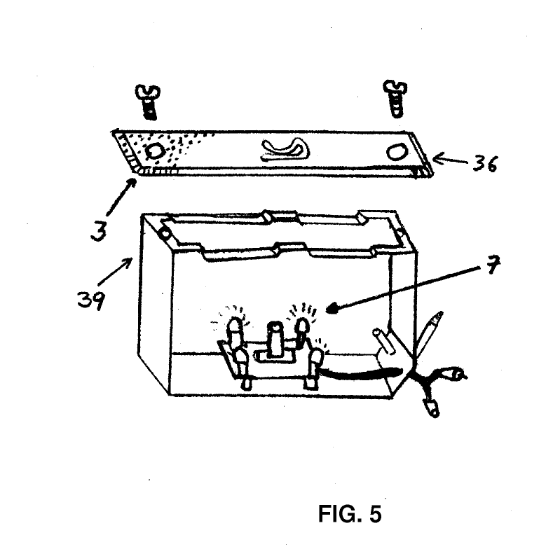

FIG. 5 is the transparent view of the invention. FIG. 5 illustrates the invention unit in a functioning prospective showing a transparent view of the inside interior of the gritty top cap 16 not properly in its place but exploded off 1 the top of the chamber. There is an optional bed frame clip (plastic or metal) 21 to hold invention to the bed frame but not limited to Velcro attachments, glue, two sided tape, or other alternative. The cap is beveled 3 of invention with surface being a gritty 16 surface both sides of cap of invention. There are two holes 36 for locking screw entrances. The two screw bolts 33 are placed thru holes shown 36 to hold tight and lock down the cap to the invention plastic Encasement embodiment 1 where there is a space ring 17 between them. The space ring 17 is to provide for a slight Air Exhaust flow from the carbon dioxide inlet 6 from within and lure smell from within interior of invention The space ring 17 also is a spacer for Bed bugs to enter thru a crack or crevice 2 of where the Cap hovers and meets over the smooth surface plastic encasement embodiment edges. As is FIG. 4, controlling the thickness of spacer ring 17 also controls the size of insects that can enter such as spiders, roaches and ticks, but not limited to. A smooth outer surface encasement embodiment 1 on all sides, that holds and protects all the interior electronics and parts that create the invention except for the protruding cable that splits 31 and the plastic carbon dioxide inlet connector 6 tube line. A small tubing connector for carbon dioxide inlet, with funnel edges 37 for easy connection and control of inletting carbon dioxide gas inlet for interior and exterior of line. The purpose of which is to introduce carbon dioxide into the interior of invention where it seeps out where the gritty cap covers the invention. This is because invention has a spacer and creates an escape crack and crevice between the cap and encasement when bolted down. As in FIG. 1 There is a plug Connection from Video NTSC, Output connector, 18 sending decoded information to Systems operating device such as Computer 10, VCR 9 or DVR 9 with common software program to the needs of motion Detection alert response. The camera and infrared light emitting diodes 7 are powered by 12 VDC connector 32 input, that must be connected for a light source in the dark chamber from a exterior 38 12 VDC source. The detection device may be positioned inside the chamber which would be able to communicate with the indicator. Communicate may include electrical signals or any other means of communication. Moreover, a control circuit may be able to control or regulate the indicator or the detection device or any combination.

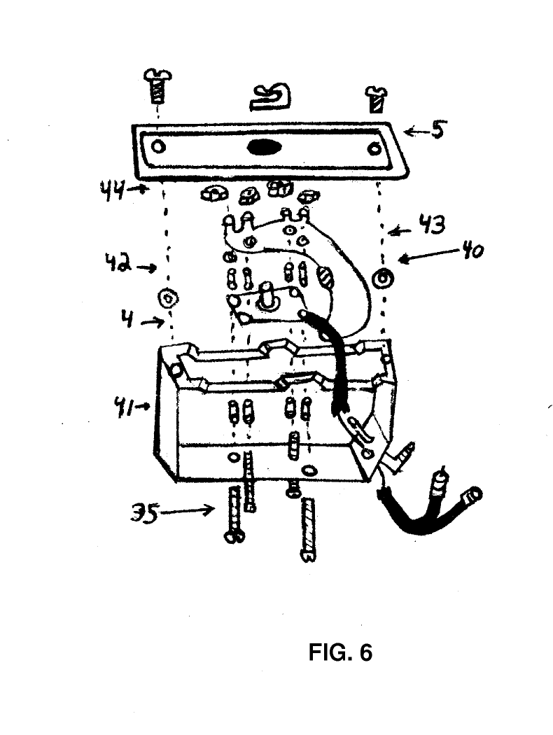

FIG. 6 is the entire exploded transparent front side view of the invention. Exploded view graphically schematically illustrates but not limited to these being the permanent proportional size of any measurements of the invention components. There is a cap beveled edge 3 of invention is 0.008 of an inch thick. 2.75 inch wide×4.25 inch long. Beveled cap of invention with surface being a gritty surface 16 both outside and inside under of the cap of invention. There is a optional bed frame clip 21 (Plastic or metal) to hold the invention to the bed frame or other objects that are 1″×1″33 0.5″ but not limited to, is attached to top of outer perimeter on top of cap of invention. It may be Velcro attachments, glue, magnets, tape, not excluding screws, clips, and brackets. There are two Screw bolts 33 one on each side, to hold tight and lock down the cap FIG. 2, 3, 1, to invention Encasement. 0.5.“Long Screw bolt thru hole shown 39, in ledge of encasement. The space ring placements 17 between Cap and embodiment of invention, to create crack and crevice for Air Exhaust flow of Co2 and lure smell emitting exiting from interior of invention. The space ring 0.25″wide cross circumference by 0.2 thick Space ring. Also acting as spacer for Bed bugs to enter thru a crack or crevice of where the hovers and meets over the invention plastic encasement embodiment edges. The smooth embodiment encasement 1 that holds and protects all the electronics and parts that creates the invention 3.5″long×2.25″wide×3″High. The wall thickness 1 of the embodiment is 0.008”. But not limited to. A smooth encasement embodiment on all sides, that holds and protects all the electronics and parts that create the invention. There is a small Co2 tube connector 6 pipe 0.25″ wide with funnel edge 37: 0.5″ long extending from exterior corner. Interior inclosing funnel 1″ long ending with orifice hole 0.05′ wide but not limited to. The purpose of which is to introduce CO2 to the interior of invention where it seeps out where the Gritty Cap cover has a escape crack and crevice between the cap and invention encasement which is made possible from the Spacer ring. A connection output; outputting from Video NTSC camera 4. This connector is 1″ long×0.25″ wide but limited to. A connection for Video NTSC, Output 18 sending decoded information to Systems operating device such as Computer 10, VCR or DVR 9, with common software program to the needs of motion detection creating first alert. The camera, and light emitting diodes are powered by 12 VDC connector input, 32 that must be connected to and from an exterior 38 12 VDC source. There are 4 but not limited to, Infrared Light Emitting Diode 7, 5 mm at 30 degrees. The infrared LEDS connected for light source in the dark chamber are in series with a power load resister 40 connection from 12 VDC. The resister 40 10 k Ohms, is so Infrared diodes 7 don't burn out. It is connected to the Positive connection of the 12 DC voltage before excessive electrons reach the diodes. Its purpose is to slow down the speed in which the electrons in the circuit flow. There is a small video NTSC Camera unit {12 VDC 125 ma} for invention 1″×1″×1″ wide. This unit is in direct connection with video feed 18 and 12 VDC power plug 32. The plastic separator tube inserts 41 0.25″long×0.1″ wide tube. Are separators for air currents and Grounding electrical circuits from static electrical connects and to stop direct static electrical connections that are not warranted. There Placements are between the bottom camera 41 and encasement embodiment. Also including separators between the top of camera 42 and Ring LED holder. 43 There are 35 small bolts, 0.75″ long×0.0085 “wide, 4 of them. These bolts are attaching all components that are camera and LED related. Static grounding tubes 41, LED ring holders 43 that are secured with the Hex nuts 44 that screw to tighten down the components to give a secured transparent picture like that of FIG. 5. The 44 hex nuts 0.1”×0.1″ for bolting, Locking down on top of led's ring holders 43 for connecting to 35 screw bolts. There is a glue board -scent lure location 5; in the middle stuck underneath the cap, 1.50′ long scented glue×0.5″ wide. 5 This is where the bedbugs maybe enticed, lured, and indicated into where they are detected by a detector. As a non-limiting example, motion may be detected with an infrared or digital camera on adjacent opposite wall from interior of invention, as in FIG. 5 connected external to motion detection software in a computerized operations system. Moreover, the digital camera may have infrared light emitting diodes in order to act as a light source in induced dark spaces for the camera. The trap device or glued insect lure gel strip constitutes a throwaway item intended for so-called one shot usage only to keep the Visual Clear on the Digital video recorder or LCD screen monitor. Replacement should be every six months and dated for visual acquisitions when no occurrences have happened.

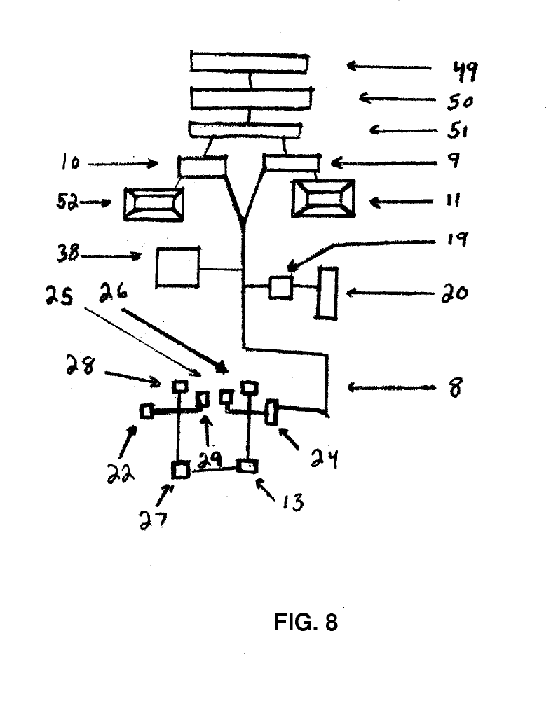

FIG. 7 is a perspective 2D view of a Room in a structure of common anonymous placements of where the invention might be placed. This is a perspective view of 16 hidden placement locations. Primarily geared for Hotel/Motel industry but not limited too. Graphically illustrates 16 invention unit Placements in Hidden Perspective view of targeting bedbug determination diagnostic technology. These Perspective locations can be in any living room including bed rooms of any Residential or Commercial Structure. First suggested location placements of invention in structural room: is disguised as two smoke alarms 45 or dome covers. The invention is attach in wall protruding behind plaster board such as a wall socket would be for example. The invention is wired within conduit to exiting baseboard area where it meets with main cable to communicate to device such as a DVR. Stealth discreet and savvy locations. Second suggested location placements of invention in structural room: is behind a mirror 46 or a picture frame. Where invention is attach in plaster board such as a wall socket would be for example, invention is wired within conduit to exiting baseboard area where it meets with main cable to communicate to device such as a DVR. Stealth discreet and savvy location. Third suggested location placements of invention in structural room: is behind head boards, two units of the invention are attached in plaster board such as a wall socket would be for example. The invention is wired within conduit to exiting baseboard area where it meets with main cable to communicate to device such as a digital video recorder. Fourth suggested location placements of invention in structural room: is under Dresser 15, closest to wall baseboard area where it meets with main cable to communicate to device such as a digital video recorder. Fifth suggested location placements of invention in structural room: is under couch 47 or in couch area where it then meets with main cable to communicate to device such as a digital video recorder. Sixth suggested location placements of invention in structural room: is where the two night Stands are next to bed underneath, 22 closet to baseboards area where it meets with main cable to communicate to device such as a digital video recorder. Seventh suggested location placements of invention in structural room: is under or in back of entertainment center 48 area where it meets with main cable to communicate to device such as a digital video recorder. Eighth suggested location placements of invention in structural room: is two more units of the invention at baseboard under beds area where it meets with main cable to communicate to device such as a digital video recorder. Ninth suggested location placements of invention in structural room: is four in each corner under box spring corners 13 at bed frame level area where it meets with main cable to communicate to device such as a digital video recorder.

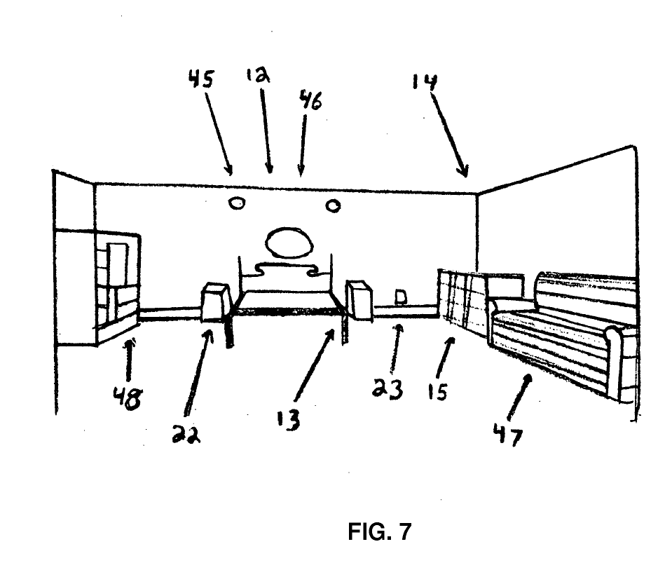

FIG. 8 is the 2D perspective view of a flow chart and for example other common reactive electronic/non electronic, operating system devices when invention is in conjunction with in order, to produce an immediate first alert digital notification to the pest management professional. The connections are compiled with each other operating type devices that unison the circuit of taxing a response warning, when a bed bug has entered and has triggered the invention. This sequence flow chart of events is starting from the received signal that the pest management professional has been notified. Trailing the path back to the original output digital triggered signals. The invention placements, and Flow Chart Design, are geared for Hotel/Motel industry installation, but not limited too. Graphically illustrates the eight invention unit Placements in Hidden Perspective view of Perspective locations 24, 26, 25, 13, 27, 29, 28, 22, in Bed room, of any Residential or Commercial Structure. This Illustration is showing placements of invention, without plaster wall breach and with product conduits attachments on the exterior of wall voids. The Illustration is showing the flow example of the connecting operating system devices that are also necessary to acquired separately to produce the signal from the invention. The indicator is an electronic message alert. One of many possible alerts is from Bed Bug Email Alert 49 on a smart cell phone that a Motion detection signal from one or more of the invention placements has had a triggered response, Also, if programmed, the user(s) will be notified if the power went offline or one of the invention placements, or is being tampered with or removed without permission of the installer of the invention without proper authorization to do so. This alert device requires an internet provider 50 is necessary. The transfer of digital information to the user's Smart phone 49 by airway control or land line depends on the internet provider also providing the pest management professional access to the users account to be able to retrieve their email account from a computer 10 or digital video recorder 9. the internet is connected to a router box 51 is a digital address of the physical location of the structure, of where the signal is going and coming from the original transfer of information produced by other computerized operating device's that have translated information of a signal(s) originality being produced from one of the invention placements. The computerized systems such as digital video recorder 9 or computer lap top 10, interpret the electrical signals that are being produced from one of the 13 invention placements. These can be, but not limited to, digital video recorder with unlimited security Camera Channels. Amount Of channels and invention placements that you decide depend on your investments with multi-channel control DVR s. This illustration is showing only a eight channel capabilities (but not limited) to monitor the information signals that are produced by the ongoing monitoring invention placements that are positioned. The operations computerized system illustration. Must have common programming that produce in that a Motion Detection sensitivity or threshold sensitivity on the matrix for every camera channel connection to work to produce a signal of the taxis response of bedbugs entering the interior of the invention placements 13. This is what produces an outgoing signal to produce a Alarm, Bells, lights or email notification on your smart cell phone. Visual monitoring 11, 52, any time to see inside invention placements are working properly is also achievable with a visual screen. This is also very important because you can not see with the naked eye if the Infrared light emitting diodes are working without the camera on and functioning. If there is any burnout of light emitting diodes the invention will not show a Picture on the 11 TV monitor. The invention needs Power from a dispersing 12 VDC Unit Box 38 with circuit breaker and fuse control for each separate invention placement, that shuts off in case of short circuits with any of the invention placements, that outputs 12 Volts Direct Current to the invention units. This power box for the invention placements runs at 800 Mil-Amps Maximum before circuit breaker shuts off the invention, That is a separate fuse circuit breaker for each invention units, with 10 Amps total for all of the power box. This is a CO2 Canister 20, with a regulator 19 that connects to a Co2 Air tube 8, which connects to all the invention placements. Each invention placement has an attached Co2 connector has a downgrade of orifice funnel FIG. 5 within and at near the entrance of the invention Co2 inlet tube. This insures quality control in slow release of the CO2 gas that's entering the inventions interior. The lines are inside a 50′ foot sheathed cable 8 that contains the power, the output for video NTSC and Plastic tubing for Co2, connecting and combining all in one sheathed cable. Flow chart is only showing eight invention location placements FIG. 8 (but not limited to.) hooked up in a series connection informational circuit for demonstration purposes and small testing areas, But not limited to. First placement of invention behind right side view, where night stand 24 would be. Second Placement of invention behind right side (top of invention connected facing Wall) behind headboard 25 is placement of invention. Third Placement of invention 26 under box spring at right front view connected at head corner of bed frame. Forth Placement of invention 13 is under box spring connected to bed frame at right view foot corner. Fifth Placement of invention 27 under box spring connected to left foot area of bed frame. Sixth Placement of invention 28 under box spring connected to bed frame for left head corner of box spring frame. Seventh Placement of invention 29 behind Left side (facing Wall) behind headboard. Eighth placement of invention 22 behind night stand area for left side.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. An apparatus for detecting insects comprising:
a chamber having an enclosure;
an attractant positioned inside said chamber;
an indicator located outside of said chamber;
a detection device which detects the presence of insects in the chamber by a detector, positioned inside said chamber which is communicatively attached to said indicator; and
a control circuit which is operably attached to said indicator and said detection device.

2. The apparatus of claim 1, wherein said chamber is a rectangular shaped box.

3. The apparatus of claim 1, wherein the attractant is a gritty surface.

4. The apparatus of claim 1, wherein the attractant is a crack or crevice.

5. The apparatus of claim 1, wherein said attractant is an insect excrement scent lure.

6. The apparatus of claim 1, wherein said attractant is a carbon dioxide inlet lure.

7. The apparatus of claim 1, wherein said attractant is warm heat from an infrared light unit.

8. The apparatus of claim 1, wherein said indicator is an electronic message alert.

9. The apparatus of claim 1, wherein said indicator is visual identification on a TV screen.

10. The apparatus for detecting insects of claim 1, wherein said indicator is an audible alarm.

11. The apparatus for detecting insects of claim 1, wherein said detector is a digital camera with infrared light emitting diodes.

12. The apparatus for detecting insects of claim 1, wherein said control circuit controls the signal to said indicator and said detection device.

13. The apparatus for detecting insects of claim 1, wherein said device may be attached to another surface by clips, screws, magnets or Velcro.

14. A method of detecting insects to a user, the method comprising the steps of:
attracting insects by an attractant to a chamber;
detecting the presence of insects in the chamber by a detector;
indicating to the user that said detector has detected the presence of insects by an indicator;
controlling the detection of the detection and indicating step by the way of a control circuit.

15. The method of detecting insects of claim 14, wherein said attractant is a bed bug excrement scent lure.

16. The method of detecting insects of claim 14, wherein said attractant is a carbon dioxide.

17. The method of detecting insects of claim 14, wherein said attractant is heat from an infrared light unit.

18. The method of detecting insects of claim 14, wherein said indicator is an electronic message alert.

19. The method of detecting insects of claim 14, wherein said indicator is visual identification on a TV screen.

20. The method of detecting insects of claim 14, wherein said indicator is a first response alert notifying a pest management professional.
